(19) United States
(12) Patent Application Publication
(10) Pub. No.: US 2010/0278592 A1
(43) Pub. Date: Nov. 4, 2010

(54) Solar Energy Cover System

(75) Inventor: Tony Walker, Scottsdale, AZ (US)

Correspondence Address: WOOD, HERRON & EVANS, LLP, 2700 CAREW TOWER, 441 VINE STREET, CINCINNATI, OH, 45202, US

(73) Assignee: Carlisle Construction Materials Incorporated, Carlisle, PA (US)

(21) Appl. No.: 12/809,878

(22) PCT Filed: Feb. 18, 2009
(86) PCT No.: PCT/US09/34419

§ 371 Date: Jun. 21, 2010

Related U.S. Application Data
(60) Provisional application No. 61/029,406, filed on Feb. 18, 2008.

(51) Int. Cl. B09B 5/00

(52) U.S. Cl. 405/129.9

(57) ABSTRACT

A solar energy cover system, landfill cover system and method of use. The solar landfill cover system typically comprises a foundation layer of compacted soil above a solid waste pile and a solar cell geomembrane on top of the foundation layer. The solar landfill geomembrane preferably comprises a flexible solar portion and a flexible water impermeable geosynthetic portion. The flexible solar portion is on a top side and comprises solar cells and the geosynthetic portion is on a bottom side and comprises a layer of a flexible water impermeable geomembrane.

### CROSS-REFERENCE TO RELATED APPLICATION

This patent application is based on and claims the benefit of U.S. provisional patent application Ser. No. 61/029,406, filed on Feb. 18, 2008, which is hereby incorporated herein by reference for all that it discloses.

### TECHNICAL FIELD

The present invention is directed to a solar energy cover system, preferably a solar landfill cover system for covering and sealing a solid waste landfill and producing electricity from solar energy.

### BACKGROUND ART

The safe disposal of waste is an ever growing, worldwide concern; and landfill technology has been developed to provide for the safe and economical disposal of solid waste. It is important when disposing solid waste into landfills that they be covered and sealed properly.

The cap is an important part of the landfill since it serves to isolate the waste in the landfill from the exterior environment. The cap prevents the exit of pathogens, toxins and odors from the landfill and prevents vermin from accessing the waste. The cap also serves a very important function in preventing access of water to the interior of the landfill; this is necessary to minimize the amount of leachate in the landfill and to preserve the integrity of the landfill bottom lining. Traditionally the cap consisted of putting a clay soil cap over the landfill site after it has been filled. Today, there are two main types of caps used. They include the older clay soil caps and the newer geomembrane caps Immediately below the cap is a foundation layer of compacted soil just above the waste pile. The foundation layer typically has a thickness of about 0.6 meters (about 2 feet) and provides support for the overlying cap. The cap (e.g., either compacted clay or a geomembrane) is then covered by a relatively thick (e.g., 0.6 meters) vegetation layer. When provided over a geomembrane cap, the vegetation layer protects the geomembrane from damage caused by UV rays, weather related damage for example.

An alternative to the traditional landfill closure systems is an exposed geomembrane cap (EGC). The EGC is basically a geomembrane cap system of the type described above, but without the vegetation layer or protective cover layer. There are several problems with EGCs however. For instance in a EGC system the geomembrane is exposed to UV rays and other weather condition which often damage and cause the geomembrane to deteriorate more quickly. The EGC also is often not permitted by state governmental agencies due to the unpleasant aesthetic features.

### DISCLOSURE OF INVENTION

The present invention is directed to a solar landfill cover system. The solar landfill cover system does not require a 2-foot (0.610 meters) thick top vegetation/protective soil layer that is required in traditional landfill caps. The present invention eliminates the need for the top layer while still maintaining integrity of the landfill cap and while providing an alternative source of energy. The present invention further prevents UV degradation that is typically present in traditional EGC's.

In one embodiment, the present invention is directed to a solar landfill cover system comprising: a foundation layer of compacted soil above a solid waste pile and a solar cell geomembrane on top of the foundation layer. The solar landfill geomembrane has a top side and a bottom side. The top side preferably comprises a flexible solar portion and the bottom side preferably comprises a flexible water impermeable geosynthetic portion. The flexible solar portion comprises solar cells while the geosynthetic portion comprises a layer of a flexible water impermeable geomembrane. In on non-limiting example, flexible solar portion is embedded in the geosynthetic portion.

The solar portion is preferably made of a thin-film (preferably about or less than 10 millimeters thick, more preferably less than 8 millimeters thick) of solar cells able to substantially conform to the landfill terrain.

The invention further includes a method of sealing solid waste in a landfill. The method generally comprises the steps of: creating a foundation layer on top of a solid waste pile by placing soil over the top of the solid waste pile and compacting the soil sufficiently to significantly lower fluid conductivity through the soil; and placing a flexible solar geomembrane over the foundation layer, the solar landfill geomembrane having a top side and a bottom side, the top side comprising a flexible solar portion and the bottom side comprising a flexible water impermeable geosynthetic portion, wherein the flexible solar portion comprises solar cells and the geosynthetic portion comprises a layer of a flexible water impermeable geomembrane to cover and seal the solid waste from penetrating water and/or release of gases from the solid waste.

In yet another non-limiting embodiment, the invention is directed specifically to a solar landfill geomembrane. Preferably the solar landfill geomembrane comprises a flexible solar portion and a flexible water impermeable geosynthetic portion, wherein the flexible solar portion is on a top side and comprises solar cells and the geosynthetic portion is on a bottom side and comprises a layer of a flexible water impermeable geomembrane. The flexible solar portion comprises solar cells. The solar cells typically comprise of flexible thin-film photovoltaic (PV) laminates. These photovoltaic laminates are flexible, durable, and lightweight. The PV laminates are usually weatherproofed with transparent polymer coating. The power-generating layer is constructed of amorphous silicon or copper indium gallium selenide (CIGS) deposited on a thin flexible metal substrate.

### BRIEF DESCRIPTION OF THE DRAWINGS

Illustrative and presently preferred embodiments of the invention are shown in the accompanying drawing in which:

FIG. 1 is a plan view of a solar energy cover system according to one embodiment of the invention;

FIG. 2 is an enlarged plan view of a solar panel array that may be utilized in conjunction with the solar energy cover system;

FIG. 3 is an enlarged cross-sectional view in elevation of the solar energy cover system;

FIG. 4 is a plan view of the electrical interconnection and grounding structure of adjacent photovoltaic modules;

FIG. 5 is a side view in elevation of the electrical interconnection and junction box placement of adjacent photovoltaic modules; and

FIG. 6 is a block diagram of one embodiment of a utility interface system that may be used to electrically connect the solar energy cover system with an electric utility system.

### BEST MODE FOR CARRYING OUT THE INVENTION

The invention will now be described in reference to the preferred embodiments of the invention for purposes of illustration only. It will be understood by one skilled in the art that numerous modifications or alterations may be made in and to the illustrated embodiments without departing from the spirit and scope of the invention.

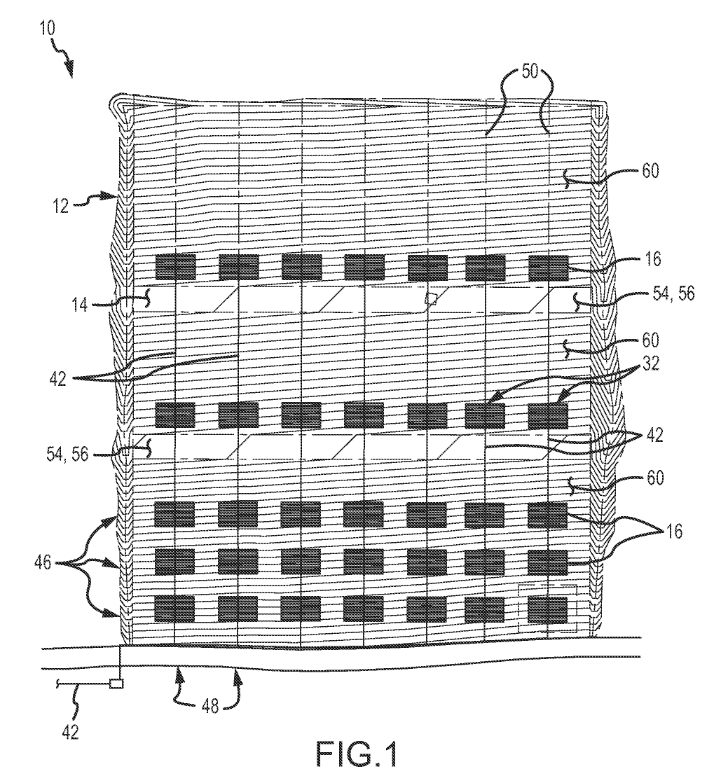

One embodiment of a solar energy cover system 10 according to the present invention is best seen in FIGS. 1-3 and is shown and described herein it may be used to cover and/or seal at least a portion, and generally the entirety, of a landfill waste pile 12. More specifically, the solar energy cover system 10 may comprise a geomembrane material 14 that is installed over and secured to at least a portion of the landfill waste pile 12 so that the geomembrane material 14 covers and/or seals the underlying portion of the landfill waste pile 12. A plurality of photovoltaic modules 16 are then provided on or otherwise operatively associated with the geomembrane material 14 so that the photovoltaic modules 16 are generally dispersed over those portions of the geomembrane material 14 that receive favorable exposure to solar energy.

In the embodiments shown and described herein, each of the various photovoltaic modules 16 comprises a generally flexible material or structure that is secured directly to the top surface 18 of geomembrane material 14, such as, for example, by an adhesive 20. Once adhered to the geomembrane material 14, the photovoltaic modules 16 and geomembrane material 14 comprise a substantially unitary, laminated structure, as best seen in FIG. 3. Stated another way, the solar energy cover system 10 comprises a flexible solar portion and a flexible, water-impermeable geosynthetic portion. The flexible solar portion is on the top surface 18 of geomembrane material 14 and comprises the photovoltaic modules 16, whereas the geosynthetic portion comprises the geomembrane material 14.

The geomembrane material 14 comprising the solar energy cover system 10 may comprise any of a wide range of materials now known in the art or that may be developed in the future that are resistant to potential damage that might be caused by sunlight, low temperatures, hail stones, high winds, tensile strain due to downslope creep, and possible punctures. Materials suitable for use as the geomembrane material 14 include, without limitation, one or more of the following materials, either singly or in combination: Ethylene propylene diene terpolymer (EPDM); high density polyethylene (HDPE); flexible polypropylene, reinforced (fPP-R); polyvinyl chloride (PVC); linear low-density polyethylene (LLDPE), medium-density polyethylene (MDPE); polyurea and polypropylene (PP); or glass and bitumem-impregnated non-woven geotextile. By way of example, in one embodiment, the geomembrane material 12 may comprise EPDM or fPP-R. In another embodiment, the geomembrane material 12 may comprise a polyester-reinforced thermoplastic polyolefin material.

The geomembrane material 14 may comprise a prefabricated continuous sheet of flexible material and may be provided in any of a wide range of thicknesses 22 (FIG. 3), depending on the particular material used as well as on the requirements of the particular installation. Consequently, the present invention should not be regarded as limited to geomembrane materials 14 having any particular thickness or range of thicknesses. However, by way of example, in one embodiment, the geomembrane material 14 may have a thickness 22 in a range of about 0.5 mm (about 20 mil) to about 3 mm (about 120 mil), more preferably a thickness 22 of about 1 mm (about 45 mil) to about 2 mm (about 80 mil), and still more preferably a thickness 22 of about 1.5 mm (about 60 mil).

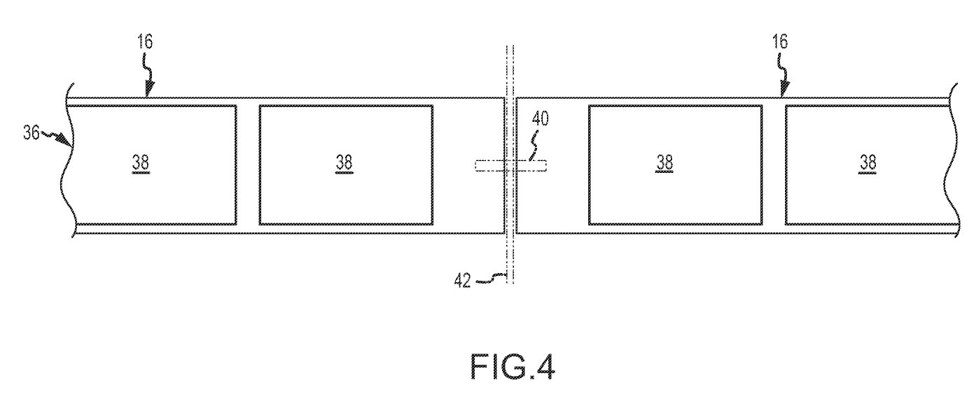

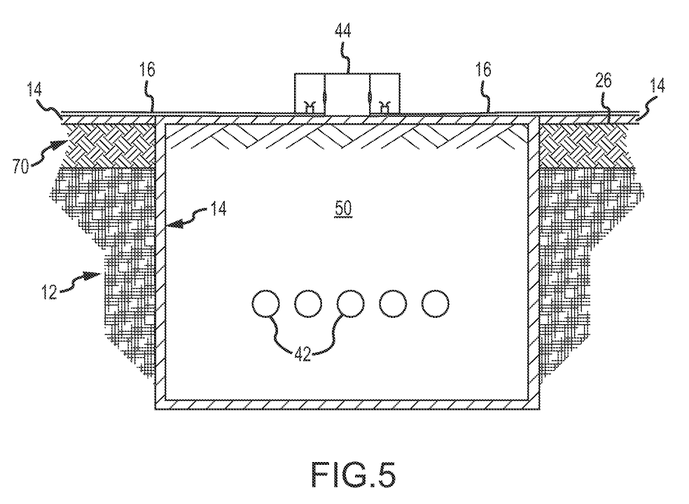

Referring now primarily to FIGS. 3 and 4, in one embodiment, each photovoltaic module 16 may comprise a laminate type of photovoltaic module having a plurality of photovoltaic cells 38 provided on a flexible substrate. The photovoltaic module 16 may be weatherproofed with a transparent polymer coating, resulting in a flexible, durable, and lightweight structure. It is generally preferred that the photovoltaic module 16 comprise a relatively thin structure, having a thickness 24 (FIG. 3) that is less than about 10 mm (about 0.4 inches), more preferably a thickness 24 of less than about 8 mm (about 0.3 inches), and still more preferably a thickness 24 of less than about 6 mm (about 0.2 inches).

The flexible nature of the photovoltaic modules 16 allows the photovoltaic modules 16 be readily mounted (e.g., adhered) to the flexible geomembrane material 14. In addition, the flexible nature of the photovoltaic module 16 allows the resulting laminated structure of the solar energy cover system 10 to substantially conform to any irregularities in the surface grade 26 of landfill waste pile 12. The resulting laminated structure also easily adjusts any settling of the landfill waste pile 12 without risk of damage to the photovoltaic modules 16 or the geomembrane material 14.

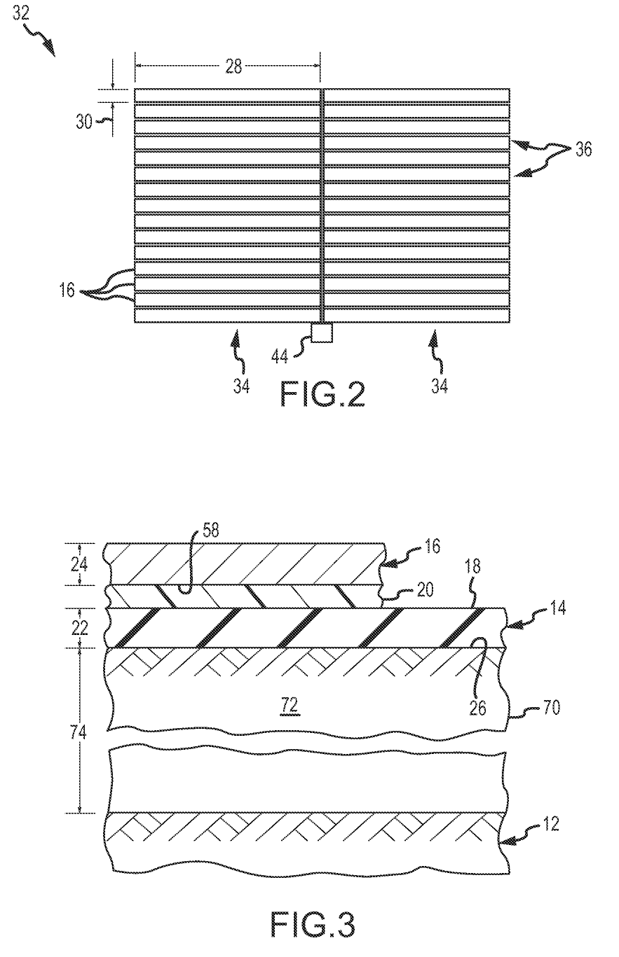

By way of example, in one embodiment, each photovoltaic module 16 may comprise a solar laminate type of photovoltaic module available from United Solar Ovonic, LLC of Auburn Hills, Mich., as model no. PVL-136 and sold under the trademark “Uni-Solar.” Briefly, and with reference primarily to FIGS. 2 and 4, each photovoltaic module 16 may comprise a plurality of active photovoltaic regions or cells 38 that are provided on a flexible stainless steel substrate. In the example embodiment shown and described herein, each photovoltaic module 16 comprises an elongated, strip-like configuration having an overall length 28 of about 5.5 meters (about 18 feet), an overall width 30 of about 0.4 meters (about 1.3 feet), and a thickness 24 of about 2.5 mm (about 0.1 inch).

As mentioned above, a plurality of photovoltaic modules 16 may be provided on (e.g., mounted to) or dispersed over the top surface 18 of geomembrane 14 at locations that are generally favorably exposed to solar energy. In one embodiment, a plurality of photovoltaic modules 18 are arranged in groups that define or form one or more solar panel arrays 32. A plurality of such solar panel arrays 32 may then be provided on the top surface 18 of geomembrane 14 in the manner best seen in FIG. 1.

More specifically, and with reference now primarily to FIGS. 2 and 4, in one embodiment, each solar panel array 32 may comprise thirty (30) individual photovoltaic modules 16 arranged in two columns 34 of fifteen (15) rows 36 each. The various photovoltaic modules 16 are generally aligned with one another so that the two modules 16 in a row 36 are generally aligned end to end, as best seen in FIG. 4. A grounding strap 40 may be used to ground and electrically tie together the appropriate electrodes of the adjacent photovoltaic modules 16. The grounding strap 40 may be electrically connected to other grounding straps (not shown) connecting other pairs of adjacent photovoltaic modules 16 by a suitable conductor (not shown) provided in an electrical conduit 42 extending between the photovoltaic modules 16 in the manner best seen in FIG. 4. Similarly, the other respective electrodes (not shown) of adjacent pairs of photovoltaic modules 16 may be electrically connected by a suitable conductor (also not shown), which conductor may also be provided in the electrical conduit 42. The electrical conductors (not shown) connecting the various photovoltaic modules 16 comprising a solar panel array 32 may be brought together in a suitable electrical junction box 44 provided adjacent the solar panel array 32, as best seen in FIG. 2.

The various solar panel arrays 32 formed or defined by the individual ones of the photovoltaic modules 16 may be provided on or dispersed over the geomembrane material 14 at locations that are exposed to favorable amounts of solar energy. By way of example, in one embodiment, the various solar panel arrays 32 are arranged so that they define a plurality of rows 46 and columns 48, as best seen in FIG. 1. In order to maximize efficiency, it will also be generally preferable to provide the various solar panel arrays 32 on generally south-facing sloped or inclined sections 60 of the surface grade 26 of waste pile 12.

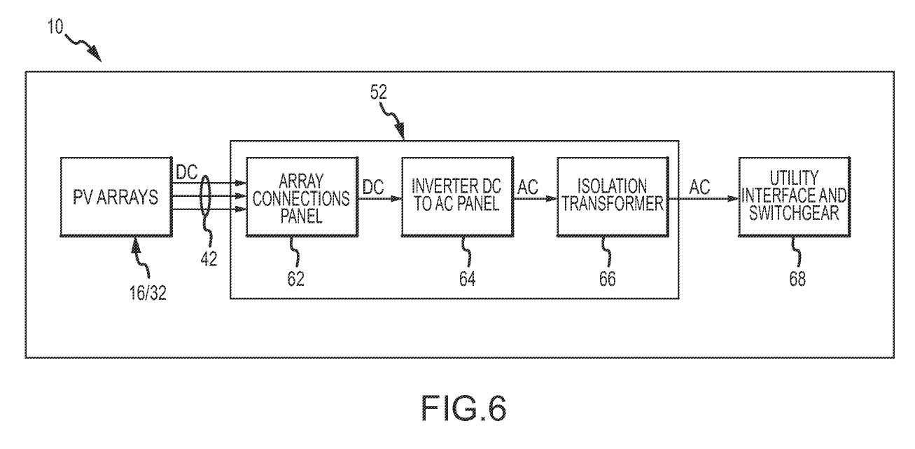

As will be described in greater detail below, the various columns 48 of solar panel arrays 32 are preferably aligned with one or more vertical anchor trenches 50 that may be formed in the waste pile 12 for the purpose of securing the geomembrane 14 to the waste pile 12. The electrical conduits 42 connecting together the various photovoltaic modules 16 comprising each solar panel array 32, and for connecting the various solar panels arrays 32 to a utility interface system 52 (FIG. 6), may be placed within the vertical anchor trenches 50, as best seen in FIG. 5.

As will also be described in greater detail below, the surface grade 26 of waste pile 12 may be provided with one or more flat areas or “benches” 54 located between adjacent sloped or inclined sections 60. The benches 54 serve as grade breaks and may also be configured to allow service vehicles and personnel to access the solar energy cover system 10. Ideally, benches 54 should be aligned with (e.g., located over) corresponding horizontal anchor trenches 56, which horizontal anchor trenches 56 may also be used to help secure the geomembrane material 14 to the waste pile 12. In most cases, solar panel arrays 32 will not be provided on the benches 54, although they could be.

As mentioned above, the various photovoltaic modules 16 may be mounted directly to the top surface 18 of geomembrane material 14 so that the resulting assembly comprises a substantially unitary, laminated structure, as best seen in FIG. 3. This mounting arrangement also allows the photovoltaic modules 16 to be mounted to the geomembrane material 14 after the same has been secured to the waste pile 12, e.g., by means of the vertical trenches 50 and horizontal trenches 56. The mounting arrangement also allows for a certain amount of “fine tuning” in the placement and arrangement of the photovoltaic modules 16 on the top surface 18 of geomembrane material 14 so that the photovoltaic modules 16 can be mounted at those locations that are most favorably exposed to solar energy, e.g., on generally southerly facing slopes 60. That is, the particular arrangement or configuration of solar panel arrays 32 need not be worked out in advance, although it could be. Rather, a suitable arrangement could be worked out once the geomembrane material 14 has been secured in place on the waste pile 12.

Referring mainly now to FIG. 3, in one embodiment, the various photovoltaic modules 16 may be secured to the top surface 18 of geomembrane 14 by means of a suitable adhesive 20. The adhesive 20 may be provided or interposed between at least a portion of the top surface 18 of geomembrane material 14 and at least a portion of a bottom surface 58 of photovoltaic module 16. It is generally preferred, but not required, that the adhesive 20 be provided over substantially the entirety of the bottom surface 58 of photovoltaic module 16 to ensure a good bond and to prevent moisture from accumulating between the geomembrane material 14 and photovoltaic modules 16.

It is generally preferred that the adhesive 20 used to mount the photovoltaic module 16 to the geomembrane material 14 have an elastic modulus that is greater than the elastic modulus of the geomembrane material. The greater elastic modulus of the adhesive 20 will allow the geomembrane material 14 to expand and contract without disrupting the bond between the photovoltaic module 16 and the geomembrane material 14. By way of example, in one embodiment, the elastic modulus of the geomembrane material 14 is such that the geomembrane material will expand and contract by up to 30% without inelastic deformation or tensile failure. The greater elastic modulus of the adhesive 20 will allow the adhesive 20 to expand by up to 300% without bond failure. Alternatively, the adhesive 20 may comprise an adhesive that will expand by up to 600% or even 700% before bond failure.

The tensile strength of the adhesive 20 may be selected so that it is less than the tensile strength of the geomembrane material 20. By way of example, in one embodiment, the adhesive 20 has a tensile strength in a range of about 110 kPa to about 138 kPA (about 16 psi to about 20 psi), and more preferably a tensile strength of about 124 kPa (about 18 psi). The lower tensile strength of the adhesive 20 will allow the photovoltaic modules 16 to debond from the geomembrane material 14 if the geomembrane material 14 experiences a tensile failure. That is, any rips or tears (e.g., tensile failure) of the geomembrane material 14 will not result in a corresponding tensile failure of the photovoltaic module 16. Consequently, any failures of the geomembrane material 14 can be repaired without the need to replace the photovoltaic module 16.

The particular adhesive 20 that may be used to bond together the geomembrane material 14 and photovoltaic modules 16 may comprise any of a wide range of adhesives that are now known in the art or that may be developed in the future, so long as they meet the foregoing requirements. Consequently, the present invention should not be regarded as limited to any particular type of adhesive 20. However, by way of example, in one embodiment, the adhesive 20 comprises an ethylene propylene copolymer material, such as SIKALASTOMER®-68.

With reference now to FIGS. 1, 4, and 6, the various photovoltaic modules 16 comprising each solar panel array 32 are electrically connected together by suitable electrical conductors (not shown) that may be provided in electrical conduits 42 in the manner already described. Each of the solar panel arrays 32 may be electrically connected to a utility interface system 52, again via suitable electrical conductors (not shown) provided in electrical conduits 42. The utility interface system 52 provides the means for electrically connecting the various photovoltaic modules 16 to an electrical load, such as, for example, a public utility system (not shown).

Referring now primarily to FIG. 6, in one embodiment, the utility interface system 52 may comprise an array connections panel 62 that allows the various solar panel arrays 32 to be electrically connected together in various series and parallel configurations to provide a direct current (DC) output of the desired voltage. An inverter system 64 electrically connected to the array connections panel 62 converts the direct current (DC) provided by the photovoltaic modules 16 to an alternating current (AC). An isolation transformer 66 provided between the inverter system 64 and a utility interface and switch gear system 68 isolates the utility interface system 52 from the a utility interface and switchgear system 68 that is connected to the public utility system.

The solar energy cover system 10 may be installed as follows over a waste pile 12 to form a landfill cover system. Assuming that the waste pile 12 has been appropriately graded, as may be required or desired for the particular installation, one or more vertical anchor trenches 50 and horizontal anchor trenches 56 may be formed in the waste pile 12. As already mentioned, the vertical anchor trenches 50 may be generally aligned with the predominate slope or grade of the sloped sides 60 of the waste pile 12. The horizontal anchor trenches 56 may be provided under (i.e., aligned with) the benches 54 or grade breaks formed in the sloped sides 60.

The vertical and horizontal anchor trenches 50, 56 may be provided at any of a wide variety of spacing intervals depending on any of a wide variety of factors, including the nature of the particular waste pile 12 and the particular type of geomembrane material 14 that is to be used. Consequently, the present invention should not be regarded as limited to any particular number or spacing of vertical and horizontal anchor trenches 50 and 56. However, by way of example, in one example embodiment, the vertical anchor trenches 50 are provided at intervals of about 18 meters (about 60 feet) along the sloped portions 60 of surface grade 26. See FIG. 1. The horizontal anchor trenches 56 may be generally aligned with the benches 54. In an alternative arrangement, a horizontal anchor trench 56 may be provided along each side of a bench 54, e.g., along the “uphill” side of bench 54 (i.e., the “toe” of slope 60) and along the “downhill” side of bench 54.

The vertical and horizontal anchor trenches 50, 56 may be made to be any convenient size and shape depending on any of a wide variety of factors, also including the nature of the particular waste pile 12, as well as on the particular type of geomembrane material 14 that is to be used. Consequently, the present invention should not be regarded as limited to vertical and horizontal anchor trenches 50 and 56 having any particular size or configuration. However, by way of example, in one embodiment, the vertical and horizontal anchor trenches 50 and 56 comprise generally rectangular configurations (when viewed in cross-section) having widths of about 1.2 meters (about 4 feet) and depths of about 1 meter (about 3 feet).

Once the waste pile 12 has been suitably formed and graded, a foundation layer 70 may be formed by placing soil 72 over the waste pile 12 and by compacting the soil 72. The foundation layer 70 is typically sufficiently compacted to substantially prevent fluid movement through it. Generally speaking, the foundation layer 70 should have a thickness 74 of at least about 50 centimeters (about 1.5 feet) and more preferably a thickness 74 of at least about 60 centimeters (about 2 feet). In one embodiment, the soil 72 used to form the foundation layer 70 comprises clay, although other materials could be used.

Once the foundation layer 70 has been formed, the geomembrane material 14 may then be placed over the foundation layer 70. In this regard it should be noted that at least a portion of the geomembrane material 14 should be placed in the anchor trenches (e.g., the vertical and horizontal anchor trenches 50 and 56) provided in the waste pile 12. In addition to the geomembrane material 14, the electrical conduit 42 may also be provided in the vertical and horizontal trenches 50 and 56 in those areas where solar panel arrays 32 are to be located. See, for example, FIGS. 1 and 5. The anchor trenches 50, 56 may then be backfilled and the backfill material compacted if necessary or desired. The backfilled anchor trenches 50, 56 may then be covered by additional quantities of geomembrane material 14, which may be attached (e.g., by welding) to the already-placed geomembrane material 14 in accordance with known field-seaming practices for such geomembrane material 14.

Once the geomembrane material 14 has been placed over the waste pile 12 and anchored, the various photovoltaic modules 16 may then be secured to the geomembrane material 14. The photovoltaic modules 16 should be arranged so as to maximize collection efficiency for the particular landfill on which the solar cover system 10 is to be used. For example, in the embodiment shown and described herein, a plurality of solar panel arrays 32 may be provided on the south-facing slopes 60 of the surface grade 26 of waste pile 12. Each such array 32 is generally aligned with (e.g., positioned over) the vertical anchor trenches 50. The various solar panel arrays 32 may then be electrically connected together, and to the utility interface system 52 be means of electrical conductors (not shown) provided in the conduits 42 buried within the vertical anchor trenches 50. Any horizontal conduit runs may be provided by means of electrical conduit 42 provided in the appropriate horizontal anchor trenches 56. Note that in the embodiment illustrated in FIG. 1, the solar panel arrays 32 are provided on the sloped portions 60, and are not provided on the benches 54, although they could be in an alternate embodiment.

The solar energy cover system 10 of the present invention represents a great improvement over the prior art, benefitting both the landfill owner and the surrounding community by providing reliable renewable energy while providing a effective landfill cap that has extended life from damage from UV rays and weather related wearing.

### EXAMPLE

One preferred non-limiting example of a solar landfill cover system and preparation of the same comprises:

Subgrade Preparation. Scarify or disc subgrade to a minimum of about 15 centimeters (about 6 inches), if necessary, to remove unacceptable large particles. Compact scarified or diced subgrade and proofroll unscarified subgrade with a steel roller having a minimum single axle weight of 10 tons. Compaction, when used, shall continue until the surface is relatively even. Subgrade material shall not have rock or gravel particles larger than about 7.6 centimeters (about 3 inches) in any dimension within the upper about 7.6 centimeters (about 3 inches) of the subgrade.

Foundation Layer. Construct foundation layer by providing soil cover to the contours and elevations indicated on the specified design drawings. The compacted soil layer forms foundation layer 70 and shall be developed by compacting successive layers having thicknesses of about 15 centimeters (about 6 inches) of approved soil material for a total compacted foundation layer thickness 74 of not less than shown on specified design drawings. Soil material shall be placed in loose lifts not exceeding about 20 centimeters (about 8 inches) in thickness. Final compacted thickness of each lift shall not be greater than about 15 centimeters (about 6 inches). Compact each lift so that the in-place dry unit weight and moisture content are according to the placement criteria. The final surface lift (e.g., about 15 centimeters (about 6 inches)) shall not contain rock or stone particles larger than about 1.3 centimeters (about 0.5 inches) in maximum dimension.

Geomembrane Installation. Prepare the soil surfaces that are to receive the geomembrane material 14 in accordance with the specified design drawings and specifications. Place geomembrane material 14 only on foundation layer 70 prepared according to the specifications and free of rutting greater than about 2.5 centimeters (about 1 inch) or sharp elevation changes. Geomembrane panel placement, seam-welding technique, placement, welding schedule shall minimize potential for accumulation of water beneath geomembrane material 14. Install the geomembrane material 14 so as to minimize trampolining of the geomembrane material 14 at the toe of slopes 60. Place geomembrane panels on slopes 60 such that upstream panels form the upper panel and overlap downstream panel in order to minimize infiltration potential. Vertical and/or horizontal anchor trenches 50, 56 will be used so that the geomembrane material 14 will be anchored along the slope 60 of the landfill. These anchor trenches 50, 56 are also used to terminate geomembrane edges, protect from wind uplift, and accommodate the thermal expansion and contraction of the geomembrane material 14. Position electrical conduits 42 within designated trenches 50, 56. Backfill the geomembrane anchor trenches with soil. Extrusion or fusion weld the adjacent geomembrane panels continuously along the full length of the panels and anchor trench.

Geomembrane Seaming. Use lapjoints to weld panels of geomembrane together. A minimum overlap of about 7.6 centimeters (about 3 inches) to be used. Seams shall be fusion or extrusion-welded. Weld area shall be free of dirt, dust, moisture or other foreign material.

Placement of Photovoltaic Modules. Prepare the geomembrane surfaces 18 that are to receive the photovoltaic modules 16 in accordance with the specified design drawings and specifications. Place photovoltaic modules 16 only on geomembrane material 14 prepared according to the specifications and free of rock or stone particles larger than about 1.3 centimeters (about 0.5 inches) in maximum dimension. Photovoltaic module placement, seam-welding technique, placement, welding schedule shall minimize potential for accumulation of water beneath photovoltaic modules 16. Adhere the photovoltaic modules 16 to the top surface 18 of geomembrane material 14 in accordance with the specified design drawings and specifications. Use a grounding strap 40 to electrically connect adjacent photovoltaic modules 16. Electrically connect the photovoltaic modules 16 in accordance with manufacturer specifications.

Having herein set forth preferred embodiments of the present invention, it is anticipated that suitable modifications can be made thereto which will nonetheless remain within the scope of the invention. The invention shall therefore only be construed in accordance with the following claims:

1-14. (canceled)

15. A landfill cover system covering a waste pile, comprising:
a foundation layer of compacted soil positioned over at least a portion of the waste pile;
a geomembrane material having a top surface and a bottom surface, the bottom surface being positioned over at least a portion of said foundation layer;
a photovoltaic module having a top surface and a bottom surface, the bottom surface of said photovoltaic module being positioned adjacent the top surface of said geomembrane material; and
means for electronically connecting said photovoltaic module to an electrical load wherein said foundation layer and said waste pile are formed to define at least one anchor trench, and wherein at least a portion of said geomembrane material conforms to at least a portion of said anchor trench to anchor said geomembrane material to said waste pile.

16. (canceled)

17. The landfill cover system of claim 15 wherein said photovoltaic module is provided on said geomembrane material at a position adjacent said anchor trench, and wherein said means for electrically connecting said photovoltaic module to an electrical load comprises at least one electrical conduit, said electrical conduit being provided in said anchor trench so that said electrical conduit is generally located below a surface grade of said landfill cover system.

18. A method for covering a waste pile, comprising:
creating a foundation layer on the waste pile by placing soil over the top of the solid waste pile and compacting the soil to form the foundation layer;
covering at least a portion of the foundation layer with a geomembrane material; and
mounting at least one photovoltaic module to the geomembrane material.

19. (canceled)

20. The method of claim 18, further comprising providing an electrical conduit within said anchor trench.

21. The method of claim 20, further comprising electrically connecting the photovoltaic module to an electrical load via the electrical conduit provided within said anchor trench.

22.-39. (canceled)

40. The landfill cover system claimed in claim 15 wherein said geomembrane is a fiber reinforced membrane.

41. The landfill cover system claimed in claim 40 wherein said geomembrane is TPO.

42. The landfill cover system claimed in claim 15 wherein said photovoltaic module is adhered to said geomembrane with an adhesive having an elastic modulus greater than an elastic modulus of said geomembrane.
